(19) United States
(12) Patent Application Publication
(10) Pub. No.: US 2026/0191149 A1
(43) Pub. Date: Jul. 9, 2026

(54) VERTICAL GROWTH SYSTEM, INSERTS AND TOOL THEREFORE, AND ASSOCIATED METHODS OF USE

(71) Applicant: 0865894 B.C. LTD. O/A AGRITECH NORTH, Dryden (CA)

(72) Inventors: Benjamin FEAGIN, JR., Dryden (CA); Samantha Charlene ALLAN, Dryden (CA); Fabian Prince VELEZ, Dryden (CA); Nicholas WOOLF, Dryden (CA)

(21) Appl. No.: 18/874,004

(22) PCT Filed: Sep. 26, 2024
(86) PCT No.: PCT/CA2024/051283

§ 371 Date: Dec. 11, 2024

Related U.S. Application Data
(63) Continuation of application No. 18/476,523, filed on Sep. 28, 2023.
(60) Provisional application No. 63/664,268, filed on Jun. 26, 2024.
(60) Provisional application No. 63/687,444, filed on Aug. 27, 2024.

(30) Foreign Application Priority Data
Sep. 28, 2023 (CA) 3215099

(51) Int. Cl. A01G 9/02

(52) U.S. Cl. CPC A01G 9/022

(57) ABSTRACT

The vertical growth system can have a plurality of inserts of different insert types which can be introduced into apertures giving access to growing media for various purposes. The insert types can include support inserts, cover inserts, footer inserts and plug inserts. Methods are use are described, including a method of introducing the inserts, and a tool which may be used to spread the apertures when mounting or dismounting the vertical growth system.

### BACKGROUND

The expression hydroponics is used to refer to the field of growing plants using water-based nutrient solution rather than soil. There are various ways of conveying the water-based nutrient solution to the plants, and a common way is to use a structure typically referred to as a column or as a tower (the expression tower will be used herein for simplicity) which can hold the plants, and a porous media into which roots of the plants may grow and via which the nutrient solution may be distributed, may be housed inside the tower. Hydroponics is an efficient way of providing high crop yield which can be used inside a building. This can be particularly helpful, for instance, for ensuring food safety in geographical regions where environmental conditions are often unsuitable to plant growth, such as in arctic communities for instance, or in providing a controlled growth environment suitable for education purposes, to name some examples.

While various hydroponics technologies have been suitable to a certain degree, there always remains room for improvement.

### SUMMARY

In accordance with one aspect, there is provided a system for growing a plant, comprising: a vertical growing structure having a plurality of interconnected walls, the walls partially enclosing a cavity, an aperture disposed through one of the plurality of interconnected walls, a growing media disposed in the cavity, wherein roots of the plant are growable into the growing media; and an insert received through the aperture, the insert including a supporting member protruding from the aperture, a first wing extending transversely from the supporting member, a second wing extending transversely from the supporting member opposite the first wing, the first wing and the second wing trapped between the growing media and the one of the plurality of interconnected walls for retaining the insert in the aperture, the supporting member supporting stems of the plant and diverting water from the plant towards the cavity.

In another aspect, there is provided an insert for a vertical plant growing structure, the insert receivable through an aperture in a wall of the vertical plant growing structure, the insert comprising: a supporting member configured for protruding from the aperture in the wall and supporting stems of a plant growing in a growing media in the vertical plant growing structure; a first wing extending transversely from the supporting member; and a second wing extending transversely from the supporting member opposite the first wing; wherein the first wing and the second wing are configured for being trapped between the growing media and the wall for retaining the insert in the aperture.

In a further aspect, there is provided a method for supporting a plant growing in a growing media in a cavity of a vertical growing structure, comprising: inserting an insert into an aperture through a wall of the vertical growing structure, the insert retained in the aperture by the growing media, a supporting member of the insert protruding from the aperture; and supporting, via the supporting member of the insert, stems of the plant, the supporting member configured for diverting water from the plant towards the cavity.

In accordance with one aspect, there is provided a support insert for a hydroponic tower, the support insert having an upper half and a lower half, the upper half having a lower edge configured to mate with an upper edge of the lower half, the upper half having an upper conduit portion, the lower half having a lower conduit portion completing the shape of the upper conduit portion to form a conduit therebetween via which a plant may be supported, the lower half and the upper half each having an outer pair of wings protruding laterally from the corresponding conduit portion, an inner pair of wings protruding laterally from the corresponding conduit portion and rearwardly spaced apart from the outer pair of wings by a gap, the gap being sized and operable to receive flaps of the hydroponic tower, the lower half and the upper half both having a height extending transversally to the orientation of the protrusion of the pairs of wings, the height corresponding to a width between the flaps of the hydroponic tower.

In accordance with another aspect, there is provided a support insert for a hydroponic tower, the support insert having an upper half and a lower half, the upper half having a lower edge configured to mate with an upper edge of the lower half, the upper half having an upper conduit portion, the lower half having a lower conduit portion completing the shape of the upper conduit portion to form a conduit therebetween via which a plant may be supported, the lower half and the upper half each having a pair of wings protruding laterally from the corresponding conduit portion, wherein the upper conduit portion has two transversally opposite lower edges which are beveled in a manner complementary to a way in which two transversally opposite upper edges of the lower conduit portion are beveled.

In accordance with another aspect, there is provided a support insert for a hydroponic tower, the support insert having an upper half and a lower half, the upper half having a lower edge configured to mate with an upper edge of the lower half, the upper half having an upper conduit portion, the lower half having a lower conduit portion completing the shape of the upper conduit portion to form a conduit therebetween via which a plant may be supported, the conduit sloping towards the rear, the upper half having two transversally interspaced walls protruding upwardly along corresponding sides of the upper conduit portion.

In accordance with another aspect, there is provided a method of engaging an insert with a hydroponics tower, the method comprising orienting the insert vertically, engaging the vertically-oriented insert into a vertically-oriented aperture formed between flaps of the hydroponics tower until the flaps of the hydroponics tower are aligned with gaps formed between a front pair of wings and a rear pair of wings of the insert, rotating the insert so as to engage the flaps into the gaps, until the insert reaches a horizontal orientation.

In accordance with another aspect, there is provided a cover insert for a vertical growth system having a tower structure having wall having a vertical slit, and growing media housed behind the wall, the cover insert being generally sheet-like and elongated along an extrusion axis, with two wing portions protruding laterally, relative the extrusion axis, from a central portion, the central portion being curvilinear with an arc-shaped cross-sectional shape, the central portion being connected to the wing portions at opposite lateral edges thereof via offsetting walls, and being forwardly offset from the wing portions, the offsetting walls projecting past the central portion and forming hook members against which free edges of the vertical slit come into abutment when in a configuration of use with the wing portions trapped between the wall and the growing media.

In accordance with another aspect, there is provided a plug insert for a vertical growth system having a vertical structure enclosing growing media and a plurality of stem conduits supporting stems of plants having roots engaged with the growing media and foliage protruding from the stem conduits opposite the growing media, the plug insert configured for engagement with stem conduits of the plurality of stem conduits which do not support stems, the plug insert having a face, an inner tube protruding from the face and designed to penetrate inside the stem channel, and an outer tube protruding from the face, at least partially surrounding and overlapping the inner tube, designed to surround the stem channel when the inner tube is engaged within the stem channel, with the front face closing out access to the growing media to light outside the vertical structure.

In accordance with another aspect, there is provided a mounting tool for a vertical growth system having growing media housed in a tower structure having an elongated slit exposing the growing media, the mounting tool comprising: a handle; and a wedge secured to the handle and having two splayed faces protruding in a narrowing manner away from the handle, the splayed faces having a plurality of transversally-oriented protrusions spaced apart from one another in the direction extending away from the handle, whereby during use, the wedge can be engaged with the elongated slit to spread the elongated slit elastically open, with free edges of the elongated slit overcoming at least one of the protrusions on each side, and wherein the protrusions can prevent the wedge from being pushed out from the elongated slit by the elastic energy stored in the tower structure following the spreading.

It will be understood that while embodiments described below and illustrated depict a vertical growing system including a variety of parts, the parts themselves will typically be sold and shipped in an unassembled state, and some parts may be purchased from different vendors. Accordingly, kits of some or all of the parts of various ones of the embodiments which are described, illustrated or discussed below are also considered be within the scope of these specifications.

All technical implementation details and advantages described with respect to a particular aspect are mutatis mutandis applicable for all other aspects.

Many further features and combinations thereof concerning the present improvements will appear to those skilled in the art following a reading of the instant disclosure.

### DESCRIPTION OF THE FIGURES

In the Figures,

FIG. 1 is a perspective view of an embodiment of a vertical growing system;

FIG. 2A is a perspective view of an other embodiment of a vertical growing system;

FIG. 2B is an exploded perspective view of the system of FIG. 2A;

FIG. 2C is a lower perspective view of the system of FIG. 2A;

FIG. 3A is a view showing mounting of a cover insert;

FIG. 3B is a view showing mounting of a support insert;

FIG. 3C is a view showing mounting of a plant;

FIG. 3D is a view showing a top of the assembled vertical growth system;

FIG. 3E is a view showing the use of a mounting tool;

FIG. 4 is a perspective view of an insert for the system of FIGS. 2A-2C;

FIG. 5 is a perspective view of an additional insert for the system of FIGS. 2A-2C;

FIG. 6 is a perspective view of a cover insert for the system of FIGS. 2A-2C; and

FIG. 7 is a perspective view of a bottom insert for the system of FIGS. 2A-2C.

FIG. 8A is a perspective view of a system for growing a plant, exploded, in accordance with an embodiment;

FIG. 8B is a perspective view of the system of FIG. 8A shown in an assembled configuration;

FIG. 8C is a cross-sectional view of a system for growing plants taken in a horizontal plane;

FIG. 8D is a cross-sectional view of the system of FIG. 8B, taken in a vertical plane;

FIGS. 9A and 9B are a front oblique view, and a rear oblique view, respectively, of an insert;

FIG. 10A is a perspective view of an alternate embodiment of an insert, with FIG. 10B being a cross-sectional view taken along lines 10B-10B of FIG. 10A;

FIGS. 11A and 11B are perspective view of an alternate embodiment of a cover insert, taken from the front and from the rear, respectively;

FIGS. 12A, 12B, and 12C are a frontal oblique view, a rear oblique view, and a cross-sectional view in an environment, respectively, of a plug insert;

FIG. 13 is a cross-sectional view in an environment of a footer insert; and

FIG. 14 is a perspective view of another embodiment of an insert.

### DETAILED DESCRIPTION

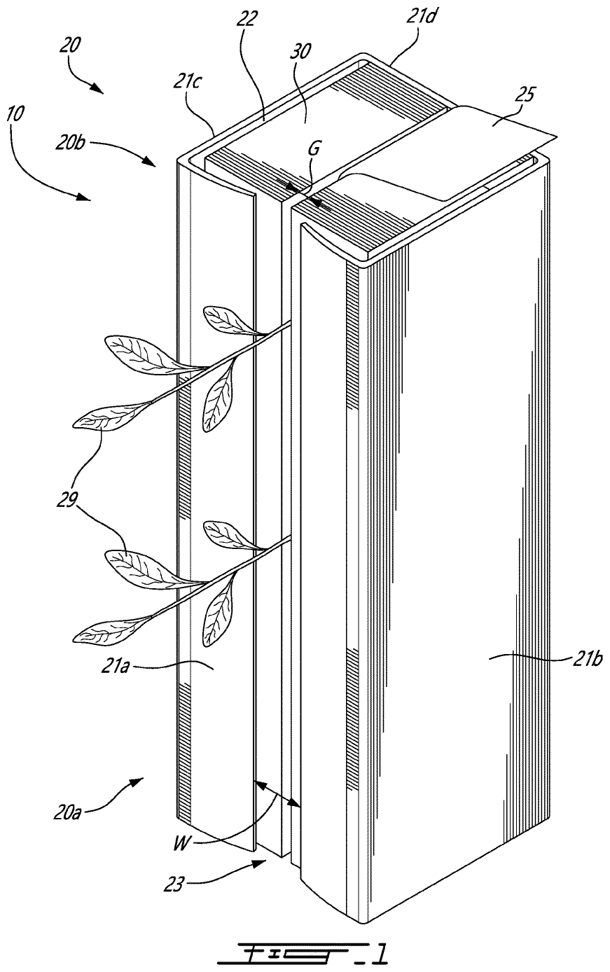

FIG. 1 shows an example of a vertical growth system 10 for growing one or more plants including a tower structure 20 and a growing media 30 disposed within the tower structure 20 in which roots of the plant are growable. Various plants may be grown via the system 10, such as leafy greens, herbs, fruity crops, flowers and cannabis. Other plants may be contemplated as well.

In the shown case, the tower structure 20 is a vertical growing tower, although other vertically-oriented growing structures, such as facias or modules, may be contemplated. The tower structure 20 presented in FIG. 1 is short or truncated to better show detail. In practice, it will be understood that the vertical growing structure can be significantly taller and all components can simply be scaled by extending along the vertical axis. The tower structure 20 includes a plurality of interconnected walls 21, illustratively a front wall 21a, side walls 21b, 21c and a rear wall 21d. The walls 21 extend from a bottom end 20a of the tower structure 20 to a top end 20b of the tower structure 20, and enclose a cavity. The illustrated embodiment has a rectangular cross-sectional shape, but other shapes may be used instead in other embodiments. An aperture 23 is disposed through one of walls 21, illustratively the front wall 21a. In the shown case, the aperture 23 is a vertical slit 23 having a width W extending along a vertical length of the front wall 21a (i.e., from the bottom end 20a to the top end 20b). Accordingly, the front wall 21a can be said to be made of two halves, with each half having a proximal edge connecting a corresponding one of the side walls 21b, 21c, and a free edge, transversally opposite the proximal edge, providing a delimitation to the aperture. In alternate embodiments, there can be more than one aperture 23, and the apertures can have various shapes and configurations. For instance, a plurality of vertical slits 23 may be provided and each extend only partially along the vertical length of one of the walls 21. In other cases, apertures in the form of a plurality of holes or perforations may be disposed through a wall 21, for instance arranged vertically from the bottom end 20a to the top end 20b, or spiral around a tower structure 20. Other apertures 23 may be contemplated.

In the illustrated example, a growing media 30, in which roots of the plant are growable, is disposed in the cavity 22. In addition, the growing media 30 may be configured for carrying water and nutriments throughout the cavity 22. Various growing media 30 may be contemplated, such as peat moss or foam. In the illustrated embodiment, the growing media 30 includes two foam blocks transversally sandwiching a sheet of porous material which can offer the function of a wicking strip 25 and be referred to accordingly. The two foam blocks and the wicking strip 25 can all extend parallel to the walls 21, within the cavity 22, and aperture 23 can provide access to the wicking strip via the line of separation between the two foam blocks. The growing media 30 can extend vertically from the bottom end 20a to the top end 20b and engage the front wall 21a, the rear wall 21d and one of the, or both, side walls 21b, 21c. A gap G disposed between the two growing media 30 can correspond to a thickness of the wicking strip. Other numbers and sizes of growing media may be contemplated, such as one or more growing media 30 partially or fully occupying the internal volume of the cavity 22.

During use, plants 29, can have a root portion introduced into the spacing between the two foam blocks, and penetrate into the cavity 22 in a manner to come into lateral abutment contact with the wicking strip 25 on a first lateral side of the wicking strip 25. At the top of the vertical growing structure, the wicking strip 25 can protrude from the top end of the foam blocks, and lay on top of one of the foam blocks, on the other lateral side. A solution of nutrients in water can be delivered to the top of the wicking strip 25, and trickle down alongside the wicking strip 25 to provide the roots with water and nutrients. The two foam blocks may be formed of a single foam component folded in half, along its length, at the bottom of the tower structure 20, for instance.

In some embodiments, for instance, the plants 29 can be introduced into the vertical growth system 10 in the following manner. A single elongated foam block can be laid flat on a horizontal surface. A wicking strip 25, forming about half the length of the elongated foam block, can be laid on top of one longitudinal half of the elongated foam block. Plants 29 can then be laid onto the wicking strip 25. The second half of the elongated foam block can be folded back on top of the plants, wicking strip, and first half, and the resulting arrangement can be slid vertically along the cavity of the tower structure 20 until it reaches its intended position. More specifically, the roots of the plants 29 can be embedded into some additional growing media, such as earth or moss, and the portion of the plants having the roots and additional growing media can be positioned on the wicking strip 25, with the stem and foliage protruding laterally from the elongated foam block.

During use, various issues may arise when using the vertical growth system 10 as described above. A first issue may be that plants 29 eventually become bigger and heavier and the weight of the fruit and/or foliage can tend to bend the main stem downwardly. Another issue which can occur is that the plants 29 will typically be spaced-apart from one another along the vertical length of the vertical growing structure, leaving some areas of the growing media 30, namely the region of growing media exposed by the aperture 23 between and around the plants, exposed to light. The growing media can be wet with the nutrient and water solution during use, and the exposure to light can make it a breeding ground for algae, mould, or other undesired growth.

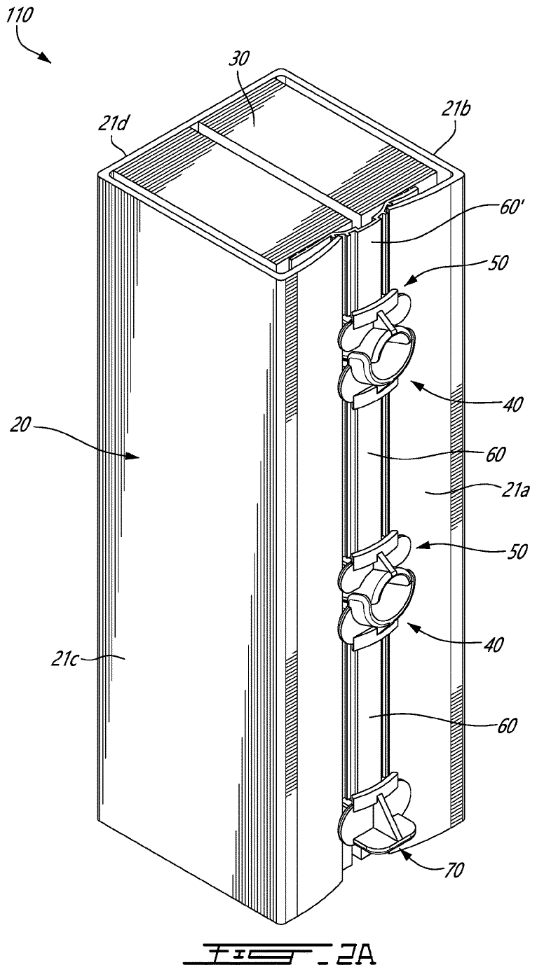

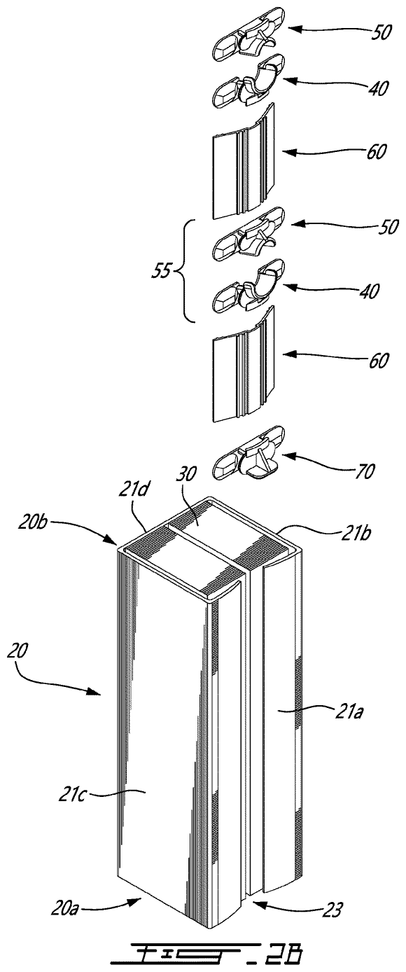

FIGS. 2A, 2B and 2C present an other embodiment of a vertical growth system 110 which includes the tower structure 20 and the growing media 30 of FIG. 1, but which further includes a plurality of additional parts 40, 50, 60, 70 which have been modularly engaged with the tower structure 20, and more specifically with faces and/or edges of the wall adjacent the aperture 23 and/or with the growing media 30. These parts will be referred to herein as inserts 40, 50, 60, 70 for simplicity. The inserts 40, 50, 60, 70 can help address issues which may arise when using the vertical growing system 10.

In particular, in this example, the inserts 40, 50, 55, 60, 70 can include a footer insert 70, cover inserts 60, and a support inserts 55 which can include, here, lower half 40 and an upper half 50. The lower half 40 can define a lower half of a stem channel, and the upper half 50 can define an upper half of a stem channel, and the lower half and upper half can be inserted adjacent to one another in a manner for the lower half and the upper half to form a channel which can circumscribe the stem. Plants (not shown) may be introduced between the lower half 40 and the upper half 50 of support insert, with the stem extending across the channel, with their roots protruding into the growing media 30. The support inserts 55 can be used to help support the plants. The support inserts 55 can further help limiting exposure of any “wet” component, such as the growing media, to light. The cover inserts 60 can help limiting exposure of the growing media to light in the region extending between plants or support inserts by covering the growing media 30 which may otherwise remain exposed. The cover inserts 60 can also somewhat help support the plants, namely by forming a column-like structure with the support inserts 55 and footer insert 70 along the vertical length of the aperture 23. Depending on the embodiment, either one, or more, of the inserts can be omitted. Each insert 40, 50, 55, 60, 70 is received through the aperture 23 (e.g., the vertical slit 23).

Before going into a detailed description of the individual ones of the inserts and some variants, it will be noted here that it may not be practical, or feasible, to introduce some, or all, of the inserts 40, 50, 55, 60, 70 into their illustrated positions after all the plants have been introduced between the foam blocks in the vertical growth system 10. Accordingly, the method described above to mount the vertical growth system 10 of FIG. 1 may not be suitable for mounting the vertical growth system 110 of FIG. 2. A different method of mounting the vertical growth system 110 of FIG. 2 may thus be preferred.

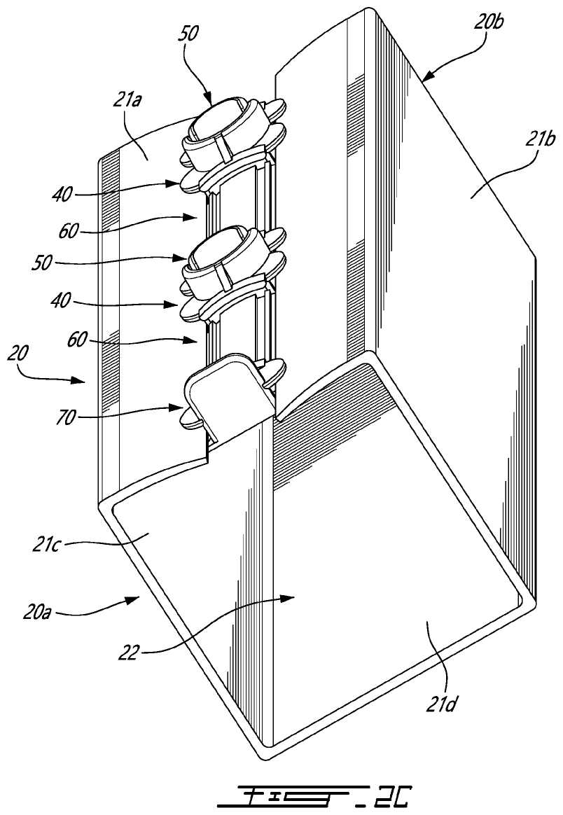

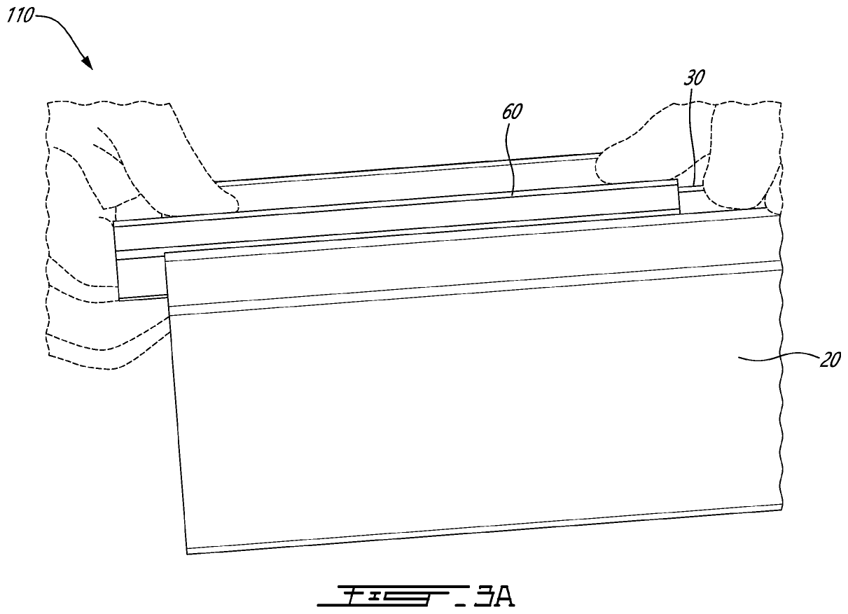

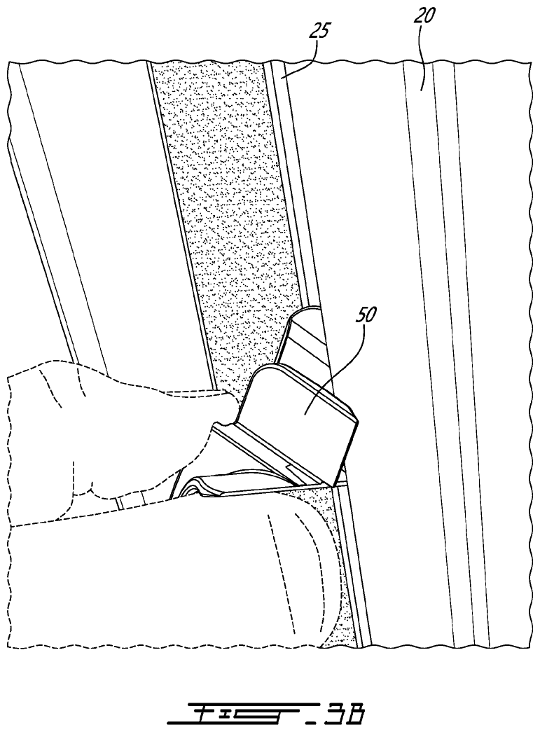

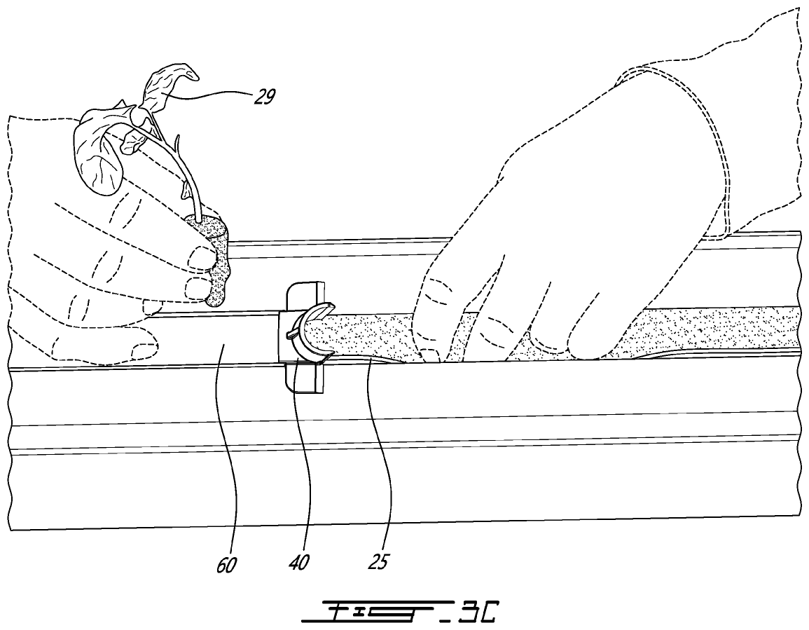

In some embodiments, the plants and inserts can be introduced to the vertical growth system 110 of FIG. 2 in the following manner. The growing media 30 may be introduced into the cavity 22 of the tower structure 20 before introducing the plants and inserts 40, 50, 55, 60, 70. Referring to FIG. 3A, the tower structure 20, with the growing media 30, can be laid on a convenient horizontal surface such as a table or workbench, with the aperture 23 facing upwardly. Some inserts can then be introduced into engagement with the tower structure 20 and growing media 30. For instance, a footer insert 70, if included, can be introduced at the bottom of the tower structure 20. A first cover insert 60 can be introduced at the bottom of the tower structure, adjacent the footer insert 70, if any. The cover insert 60 has wings protruding laterally from an arcuate central portion. The cover insert 60 is flexible transversally, and the wings can be folded closer to one another to help introduce them into place between corresponding portions of the front wall 21a and the growing media 30. The tower structure 20 can also have some flexibility, and the two edges adjacent the aperture 23 can be spread apart from one another to facilitate this, as shown in FIG. 3A. Alternately, the cover insert 60 can be introduced at an end of the vertical structure 20 and slid longitudinally into place. The top end of the cover insert 60 can define the location of the lower half 40 of the support insert 55, which can then be introduced. The halves 40, 50 of the support insert 55 can be introduced by engaging them into the aperture 23 in the orientation of an axis of the stem channel, with the wings extending in a first orientation coinciding with the orientation of the vertical slit, and then turning them, around an axis of the stem channel, into a horizontal orientation, into engagement with the free edges, as schematized in FIG. 3B.

Referring now to FIG. 3C, the position of the lower half 40 can dictate the position of the first plant 29. The first plant 29 can then be inserted into position, which may benefit from manually creating a space for the root portion by stretching the first foam block transversally away from the second foam block and wicking strip 25, such as shown in FIG. 3C, before inserting the root portion. This can ensure that the root portion can be inserted sufficiently deep to correctly engage the wicking strip 25. The top half of the support insert 50 can then be engaged similarly to the lower half (see FIG. 3B), by introducing in a vertical orientation, rotating into the horizontal orientation, and then sliding along the length of the aperture 23. The process can be continued independently of the length of the vertical growth system 110, by adding cover inserts 60 and support inserts 55 until the top is reached, such as shown in FIG. 3D. As shown in FIG. 3E, any one of these steps may be facilitated via the use of a mounting tool 80 which can help maintain the edges of the front wall elastically spaced apart from one another while a manipulation of a given insert, or plant, can be performed more freely by both hands.

The mounting tool 80 will now be discussed in greater detail with reference to FIGS. 3E, 3F and 3G. More specifically, the mounting tool 80 is shown alone, from an angle, in FIG. 3F, whereas the mounting tool's transversal cross-sectional profile is illustrated in greater detail in FIG. 3G. In this embodiment, defining features of the mounting tool 80 include a handle 82 and wedge 84 both extending in sequence along a longitudinal axis. The mounting tool 80 can be manually held by the handle 82, somewhat like a dagger, and be oriented so that its longitudinal axis 86 is made normal to the orientation of the vertical slit 23 and of the front wall 21a, and for the width 88 of the wedge 84 to extend normal to the orientation of the vertical slit 23. From that orientation, the mounting tool 80 can be moved in the orientation of the longitudinal axis, and “stabbed” into the aperture 23. From there, longitudinal force exerted in the orientation of the longitudinal axis will be redirected as transversal force against the free edges of the front wall 21a which delimit the vertical slit or aperture, elastically deforming the tower structure 20 and spreading the free edges away from one another, into the configuration shown in FIG. 3E. Simultaneously the foam blocks may also be spread apart from one another to a certain extent by the mounting tool 80.

When the tower structure 20 has a degree of elasticity, such as by being made of a suitable polymeric material (which may also have other desirable features such as low porosity), the energy from the stabbing motion can become stored, to a certain extent, in the elastic deformation of the polymeric material, and may tend exert a returning force which could result in “popping” the mounting tool 80 back out, which might be inconvenient. To avoid this potentially undesired effect, the splayed faces of the mounting tool which define the wedge can bear protrusions, or “teeth”. There can be a single protrusion on each one of the faces (e.g., on each transversal side), or a set of regularly, or irregularly interspaced protrusions (spaced from one another along the axis, or along the splayed faces) along both faces, or both sides. The protrusions can offer resting places for the free edges of the aperture. The latter configuration can offer a plurality of resting places corresponding to a plurality of different spacings between the free edges. In the embodiment shown in greater detail in FIG. 3G, the forcing of the wedge into the aperture can also have the effect of elastically snapping the free edges over a number of the protrusions, until the user deems the degree of spacing between the free edges suitable for the current situation of use. Once the user releases the handle 82, even if the elastic energy stored in the tower structure 20 has the effect of pushing the free edges against the wedge shape 84, and accordingly pushing the wedge shaped tip out from engagement with the aperture/free edges, the action of the elastic energy can be stopped by the interference generated by the protrusions against which the free edges can become trapped such as shown in FIG. 3G. The protrusions can be of a dimension and shape which allows both suitable snapping functionality and trapping functionality, as described above. Different shapes can be used. The ridges can have relatively smooth edges to prevent damage to the free edges of the front wall during the process. In the embodiment presented in the figures, square cross-sectional shaped ridges were selected for the protrusions, but this is only one of numerous possible shapes. In this manner, the degree of trapping can be adapted to be easily overcome by applying a retracting force to the handle which can snap the free edges back over the protrusions, and allow to withdraw the tool.

While in practice, only a relatively limited longitudinal length of wedge, having dimensions beginning just below, and finishing to a suitable degree above, the width of the aperture in the rest configuration, may be suitable, it may be desired instead to increase the longitudinal span of the wedge, be it for providing for more flexibility of use or for providing the ability to spread the growing media in addition to spreading the aperture. In the embodiment illustrated, the wedge has two wedging sections, including a main wedging section bearing the protrusions and having two faces splayed at a first angle, and a tip wedging section having two flat faces free of protrusions splayed at a second angle, greater than the first angle. In the embodiment illustrated in FIG. 3F, the wedge portion terminates, adjacent the handle, by a transversally-extending stop. The stop can have the function of preventing further penetration of the wedge shaped tip into the aperture, acting as an abutment for the user's hand to apply longitudinal force or arrest longitudinal movement, or both.

In the embodiment illustrated, the wedge 84 has a shape corresponding to an extrusion of a two-dimensional shape along an axis which is normal to both the longitudinal axis 86 and the width 88 of the wedge shape, while the handle 82 has a generally cylindrical solid of revolution shape defined around the longitudinal axis, with some circumferential ribs to provide friction. These features were found suitable but there are many different ways to implement the tool 80 in alternate embodiments. It will also be understood that the mounting tool 80 can equally be used when unloading plants from the vertical growth system 110 (harvesting), and is thus restricted for use in “mounting”.

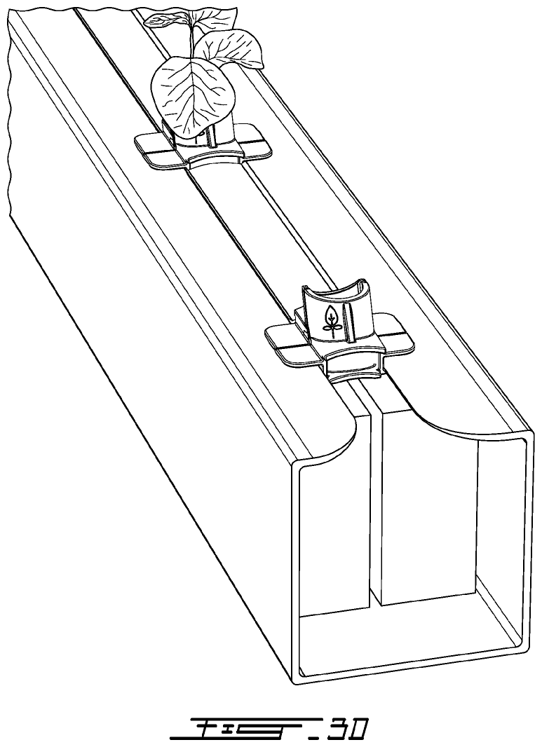

Individual ones of the inserts 40, 50, 55 60 and 70, from the embodiment of FIGS. 2A to 2C, will now be described in greater detail. Turning now to FIG. 4, the lower half 41 include a supporting member 41 for supporting the root of the plant (or other portion of the plant(s)) from a bottom thereof, and wings 42, illustratively two wings 42, for retaining the insert 40 in the aperture 23a. The supporting member 41 illustratively protrudes from the aperture 23 and is operable to support roots or stems of the plant, and divert water from the plant towards the cavity 22. In the shown embodiment, but not necessarily the case in all embodiments, the supporting member 41 slopes upwardly as it protrudes outwardly from the aperture 23. This upward slope may, for instance, assist in diverting water towards the cavity 22 and to counter plant sagging. The angle of the upward slope may vary. In the shown case, the supporting member 41 includes a base portion 41a disposed between the wings 42 and an upper portion 41b, disposed above the base portion 41a, and on which the plant roots or stems are supported. In the shown case, the upper portion 41b has a semi-circular cross section, although other shapes may be contemplated. The depicted supporting member 41 further includes a bottom portion 41c disposed below the base portion 41a. The bottom portion 41c is configured for engaging with other insertable components of the system 10, as will be discussed in further detail below. The dimensions of the base portion 41a may vary, for instance based on the size of the aperture 23 to ensure proper insertion and retention thereinto.

As discussed above, the depicted insert 40 includes two wings 42, each wing 42 extending transversely opposite the other wing 42. Once the insert 40 is inserted, the wings 42 are configured for retaining the insert 40 in the aperture 23 by being trapped between the growing media 30 and a wall 21, illustratively the front wall 21a. Other numbers and orientations of wings 42 may be contemplated. In the shown embodiment, the wings 42 include a raised or ribbed portion 42a to assist with engagement with the wall 21 and/or the growing media 30, and to assist with water management. In some cases, the insert 40 may be inserted into the aperture 23 with the wings 42 oriented vertically. Once inserted, the insert 40 may then be rotated, for instance by 90 degrees, so that the wings 42 are oriented horizontally and are engageable with the growing media 30 and front wall 21a. Other insertion means may be contemplated, for instance by sliding one wing 42 into the aperture 23 before sliding in the other wing 42.

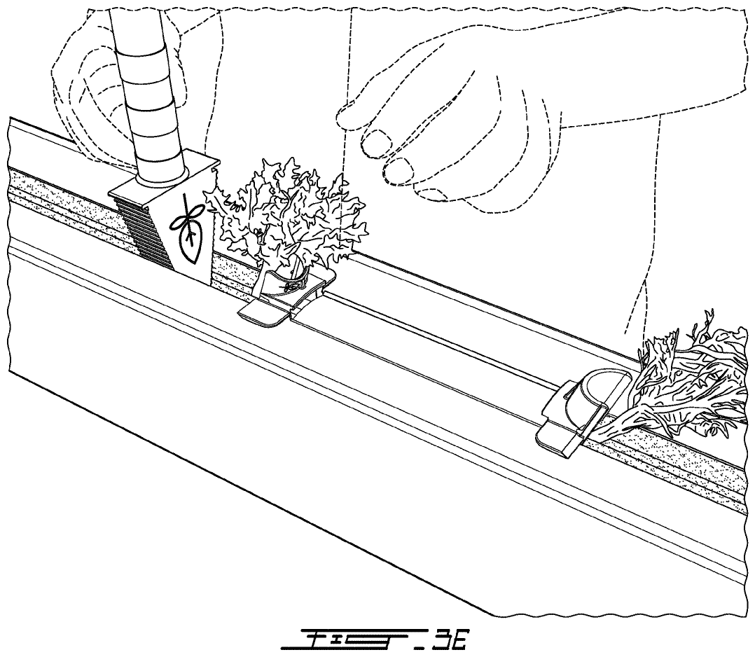

Referring additionally to FIG. 5, in some cases the system 10 may be provided with one or more optional additional inserts 50 (two additional inserts 50 shown in FIGS. 1A-1C). The additional inserts 50 are received through the aperture 23 (e.g., the vertical slit 23) and may be complementary to corresponding inserts 40. Stated differently, each additional insert 50 may be disposed above a corresponding insert 40 in the aperture 23 to assist with supporting a portion of a plant. Each additional insert 50 illustratively includes a supporting member 51 for supporting the root of the plant (or other portion of the plant(s)) from a top thereof. and wings 52, illustratively two wings 52, for retaining the insert 50 in the aperture 23.

The supporting member 51 illustratively protrudes from the aperture 23 and is operable to support roots or stems of the plant, and divert water from the plant towards the cavity 22. In the shown embodiment, but not necessarily the case in all embodiments, the supporting member 51 slopes upwardly as it protrudes outwardly from the aperture 23. This upward slope may, for instance, assist in diverting water towards the cavity 22. The angle of the upward slope may vary. In the shown case, the supporting member 51 includes a base portion 51a disposed between the wings 52 and a lower portion 51b, disposed below the base portion 51a, and assists in supporting the plant roots or stems. In the shown case, the lower portion 51b has a semi-circular cross section, although other shapes may be contemplated. The shape of the supporting member 51 may mirror that of the supporting member 41. The depicted supporting member 51 further includes an upper portion 51c disposed above the base portion 51a. The upper portion 51c is configured for engaging with other insertable components of the system 10, as will be discussed in further detail below.

As discussed above, the depicted additional insert 50 includes two wings 52, each wing 52 extending transversely opposite the other wing 52. Once the additional insert 50 is inserted, the wings 52 are configured for retaining the insert 50 in the aperture 23 by being trapped between the growing media 30 and a wall 21, illustratively the front wall 21a. Other numbers and orientations of wings 52 may be contemplated. In the shown embodiment, the wings 52 include a raised or ribbed portion 52a to assist with engagement with the wall 21 and/or the growing media 30, and to assist with water management. In some cases, the insert 50 may be inserted into the aperture 23 with the wings 52 oriented vertically. Once inserted, the insert 50 may then be rotated, for instance by 90 degrees, so that the wings 52 are oriented horizontally and are engageable with the growing media 30 and front wall 21a. Other insertion means may be contemplated. In some cases, each additional insert 50 is disposed immediately above a corresponding insert 40 (i.e., with the supporting members 41, 51 abutting one another). In other cases, for instance where the roots of the plant occupy more space, each additional insert 50 may be vertically spaced apart from a corresponding insert 40. Other arrangements, for example combinations of the above, may be contemplated.

Referring additionally to FIG. 6, the system 10 may be provided with one or more optional cover inserts 60, which can alternately be referred to herein as cover inserts 60 (illustratively two cover inserts 60 and an additional cover insert 60′are shown in the embodiment of FIG. 2A) to at least partially cover (i.e., block light from entering) the vertical slit 23 along its length. The cover inserts 60 may also provide stability to the vertical growing structure 20. Each depicted cover insert 60 includes a front side 60a (facing away from the cavity 22) and a rear side 60b (facing towards the cavity 22), and further includes a covering portion 61 and two side portions 62, or wings. The covering portion 61 may be sized to correspond with the width W of the vertical slit 23 so that light is prevented from entering the cavity 22 via the vertical slit 23, while the side portions 62 extend transversely from the covering portion 61 and are configured for retaining the cover 60 in the vertical slit 23. For instance, the side portions 62 may become trapped between the growing media 30 and the front wall 21a.

In some cases, the side portions 62 may be bendable or foldable towards one another, relative to the covering portion 61, to assist with the insertion of the cover 60 within the vertical slit 23. In addition, protrusions such as ribs 63a, 63b may be disposed on the front side 60a and/or the rear side 60b to assist with engagement with the front wall 21a and/or the growing media 30. In particular, it was found that providing rearwardly-facing protrusions 63b around the distal portions of the side portions 62, or close to the free lateral edges, could engage the growing media 30 and be useful in helping to maintain a desired position of the cover 60 relative to the tower structure 20. Moreover, it was found that providing forwardly facing protrusions 63a at or in the vicinity of the central covering portion 61, could be useful to provide lateral abutments for the free edges of the aperture 23, and help maintain a desired relative configuration between the cover 60 and the tower structure 20. Having a central covering portion which is forwardly (or potentially rearwardly) offset from the side portions, such as by offsetting walls 69, can help in providing buckling resistance when the cover 60 is subjected to compression stress in the vertical orientation associated to its configuration of use relative the vertical slit 23, while leaving suitable transversal pliability (e.g., allowing to fold and bend the side portions 62 towards one another) to facilitate engagement of the cover into the vertical slit.

In the illustrated embodiment, the cover 60 is designed for production by extrusion of a two-dimensional cross-sectional shape along an extrusion axis. Accordingly, the front-facing protrusions 63a, the rear-facing protrusions 63b and the offsetting walls 69 extend linearly, parallel to the extrusion axis, and are defined by corresponding portions of the two-dimensional cross-sectional shape of the cover, which protrude from elongated portions corresponding to the side portions 62 and covering portion 61. The covering portion 61 itself being arcuate-shaped, which was found to promote pliability while offering buckling resistance.

The number and size of cover inserts 60 may vary. In the shown case, two cover inserts 60 are provided to occupy the empty space in the aperture 23 between other insertable components. The number and/or size of the cover inserts 60 may thus vary, for instance to accommodate varying sized vertical growing structures 20 or different numbers and/or sizes of other insertable components. In addition, the bottom portions 41c of the inserts 40 and the upper portions 51c of the additional inserts 50 may be configured for engaging with the cover insert 60 so that the various components in the vertical slit 23 support one another in a vertical direction. The additional cover insert 60′, also referred to as the uppermost cover insert 60′, may be dimensioned to occupy the space in the slit 60 between the uppermost insert 40 (or additional insert 50, as shown in FIG. 1), and the top end 20b to prevent light from entering through the slit 60 at this location. The uppermost cover insert 60′, along with the top end 20b, may form a closed or continuous upper permitter for the vertical growing structure 20. In the shown case, the uppermost cover insert 60′is shorter in length than the cover inserts 60, and otherwise has the same general structure and shape. In some cases, based on the overall length of the vertical growing structure 20, one of the cover inserts 60 may be used as the uppermost cover insert 60′).

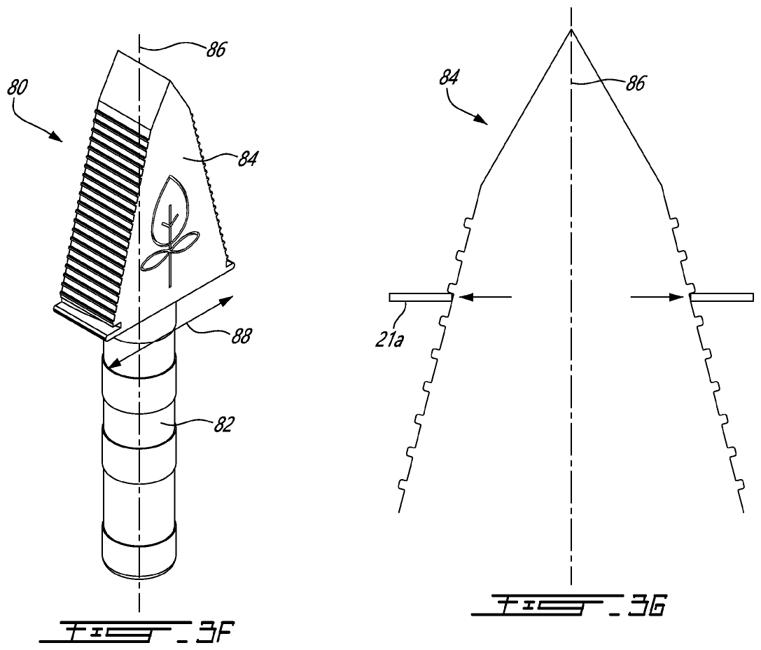

Referring additionally to FIG. 7, the system 10 may include a bottom insert 70, or footer insert, received through the vertical slit 23 and disposed below a lower-most of the other insertable components, illustratively a lowermost of the cover inserts 60. The bottom insert 70 is configured to be the lower-most insertable component of the system 10 and thus provide support to the other insertable components. The depicted bottom insert 70 includes a base portion 71a, an upper portion 71b engageable with the component disposed above the bottom insert 70 (illustratively a cover insert 60), a planar bottom portion 71c for optionally engaging with the ground for support, and wings 71, illustratively two wings 71, for retaining the bottom insert 70 in the aperture 23. In the shown case, the bottom insert 70 is vertically spaced from the bottom end 20a of the vertical growing structure 20, for instance to accommodate for the vertical growing tower 20 sitting in a trough. Other arrangements may be contemplated, such as the bottom insert 70 being disposed immediately at the bottom end 20a, or a cover insert 60 being disposed between the bottom insert 70 and the bottom end 20a.

As discussed above, the depicted bottom insert 70 includes two wings 72, each wing 72 extending transversely opposite the other wing 72. Once the bottom insert 70 is inserted, the wings 72 are configured for retaining the bottom insert 70 in the aperture 23 by being trapped between the growing media 30 and a wall 21, illustratively the front wall 21a. Other numbers and orientations of wings 72 may be contemplated. In the shown embodiment, the wings 72 include a raised or ribbed portion 72a to assist with engagement with the wall 21 and/or the growing media 30. In some cases, the bottom insert 70 may be inserted into the aperture 23 with the wings 72 oriented vertically. Once inserted, the insert 70 may then be rotated, for instance by 90 degrees, so that the wings 72 are oriented horizontally and are engageable with the growing media 30 and front wall 21a. Other insertion means may be contemplated.

In accordance with this disclosure, an exemplary method for supporting a plant growing in a growing media 30 in a cavity 22 of a vertical growing structure 20 is disclosed. An insert 40 is inserted into an aperture 23 through a wall 21 of the vertical growing structure 20, the insert 40 retained in the aperture 23 by the growing media 30, a supporting member 41 of the insert 40 protruding from the aperture 23. The supporting member 41 of the insert 40 supports stems of the plant, the supporting member 41 configured for diverting water from the plant towards the cavity 22.

In an embodiment, inserting the insert 40 further includes inserting the insert 40 through the aperture 23 with wings 42 of the insert 40 disposed in a vertical orientation, and subsequently rotating the insert 40 such that the wings 42 are disposed in a horizontal orientation, the wings 42 confined between the wall 21 of the vertical growing structure 20 and the growing media 30.

In an embodiment, the aperture 23 is a vertical slit 23 extending along a vertical length of the wall 21, and inserting the insert 40 further includes inserting a plurality of the insert 40 through the vertical slit 23.

In an embodiment, one or more additional inserts 50 are inserted above each of the plurality of the insert 40 to vertically surround the stems of the plant.

In an embodiment, a plurality of cover inserts 60 are inserted into in the vertical slit 23 between adjacent ones of the plurality of the insert 40 to substantially cover the vertical slit 23.

As discussed above, while the depicted vertical growing structure 20 includes a vertical slit 23, other apertures 23 may be contemplated. For instance, one or more holes or perforations may be arranged along one of the walls 21, for instance a plurality of vertically arranged holes or perforations, with each hole or perforation receiving an insert 40 and optionally an additional insert 50. The shape of such holes or perforations may vary, for instance in order to accommodate the various inserts 40, 50. In such cases, the cover inserts 60 may be omitted, as light may be prevented from entering the cavity 22 due to the absence of openings beyond the holes occupied by inserts 40. Other apertures 23 may be contemplated.

Advantageously, the various insertable components (illustratively the inserts 40, additional inserts 50, cover inserts 60 and bottom insert 70) may divert water back into the cavity 22 and substantially block or conceal the vertical slit 23, i.e., prevent light from entering cavity 22 via the opening 23. This may, for instance, abate algae and other growth inside the cavity 22. Leaks may also be mitigated due to the insertable components.

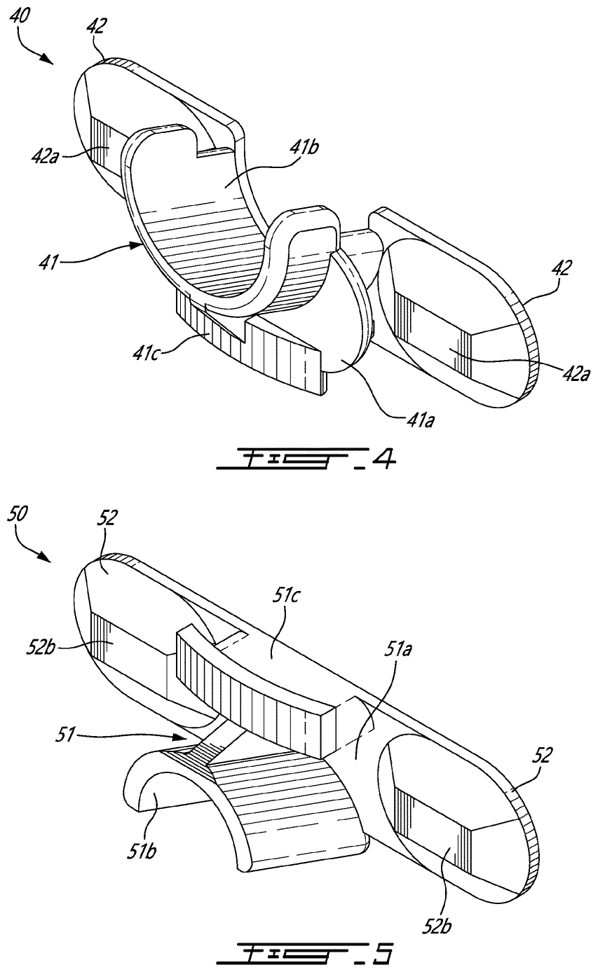

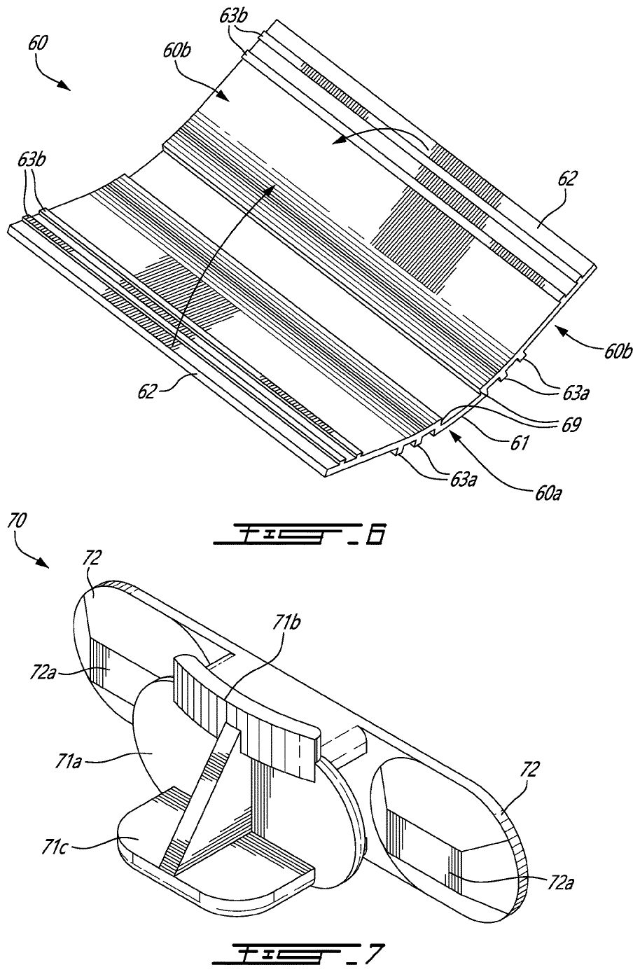

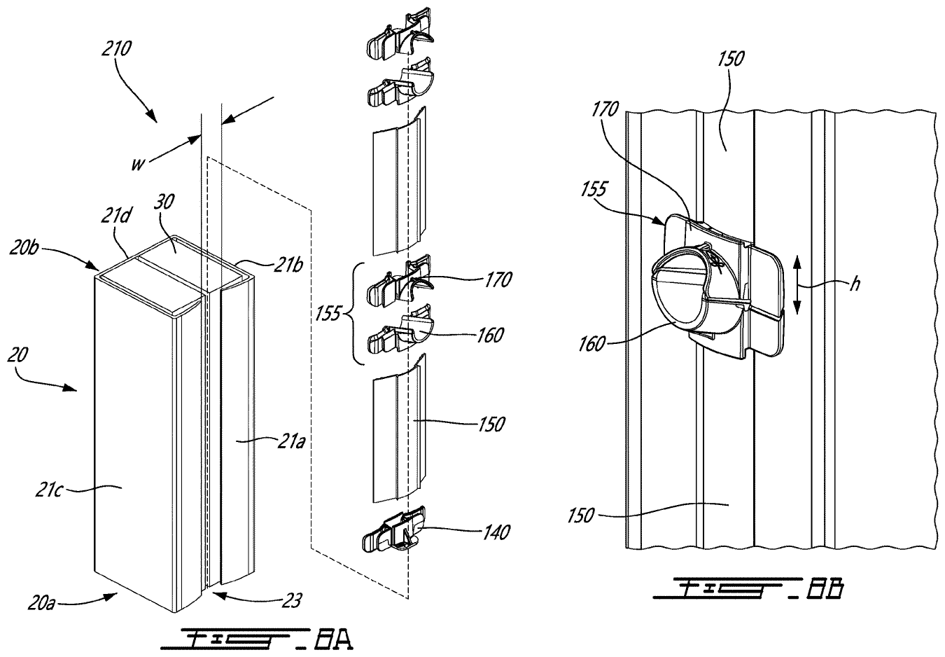

FIGS. 8A to 8D present an alternate embodiment of a vertical growth system 210 where the tower structure 20 and growth media 30 is similar to the embodiment presented in FIGS. 2A to 2C, but where the inserts 140, 150, 155, 160, 170 are different. The inserts 140, 150, 155, 160, 170 of this embodiment will be referred to using numerals in the 100 series.

Inserts 140, 150, 155, 160, 170 can be inserted in one or more aperture 23 defined in the tower structure 20. In this embodiment, the aperture 23 in the form of an elongated, vertically-oriented slit having a width w and extending along the full height of the tower structure 20. Inserts 140, 150, 160, 170 may be placed into position by sliding along the aperture 23 from top to bottom, or by inserting at an intermediary location along the height of the aperture 23 and potentially sliding along a limited height. Inserting at an intermediary location may involve folding and releasing a cover insert 160 for instance, or inserting a support or footer insert in a vertical orientation and then pivoting into a horizontal orientation of use for example, such as detailed above in relation with FIG. 3B. In this embodiment, a sequence of inserts can include, from bottom to top, a footer insert 140, a cover insert 150, a support insert 155, a further cover insert 150, a further support insert 155, and the sequence of further cover insert 150 and further support insert 155 can be repeated until an arbitrary length of the tower is reached. The cover insert 150 can impede light transmission to the growing media 30 between support inserts. In this embodiment, the footer insert 140 can support the weight of a cover insert 150 and potentially the weight of more inserts above, particularly when support inserts 155 are loaded with plants. Depending on the embodiment, the footer insert 140 may be omitted. Depending on the embodiment, the cover insert 150 may be omitted. Various plants may be grown via the system 10, such as leafy greens, herbs, fruity crops, flowers and cannabis. Other plants may be contemplated as well.

FIG. 8B presents a close-up view of the support insert 155, including the bottom half 160 and the upper half 170, in more detail, shown in the assembled configuration in the aperture 23, with a cover insert 150 below it and a cover insert 150 above it.

During use, the cavity circumscribed by the walls of the tower structure 20 can be very humid due to the circulation of the water-based nutrient solution. Occasionally, water droplets may form outside the tower structure 20 (e.g., on an outer face of the walls 21a-21d, opposite the internal cavity, due to condensation), or escape from the cavity across the aperture 23. It can be desired to keep the inside of the cavity as dark as possible, to avoid or impede growth of moulds and/or algae. It can also be desired to keep the outside of the cavity as dry as possible, to avoid or impede the growth of moulds and/or algae. It will be noted that various features of the inserts 140, 150, 155, have been engineered to promote either one, or both of these goals, and/or to otherwise facilitate use while minimizing maintenance and costs, as will now be described.

Firstly, referring to FIG. 3B, and also to FIG. 8D, it will be seen how a support insert 55, more specifically an upper half 50 in this example, can be inserted into the aperture 23. Each half 140, 150 can have a height h (see FIG. 8B) which can be adapted to the width w of the aperture 23. The upper half 150, taken in this example, can be pivoted 90 degrees, for the height h to extend in the same orientation than the width w, which will be referred to as the vertical orientation, and then engaged in a manner for a rear portion thereof to be engaged into the cavity, across the aperture. From there, the upper half can be rotated into the orientation shown in FIG. 8B, which will be referred to as the horizontal configuration, corresponding to its orientation of use. Both the upper half 150 and the lower half 140 of the support insert 155 can each include an outer pair of wings and an inner pair of wings which can be seen more clearly in the cross-sectional view shown in FIG. 8C. When introduced in the vertical orientation, the free flaps of the front wall 21a of the vertical structure 20, which are spaced apart from one another by the aperture, can become engaged between the wings of the outer pair and the wings of the inner pair, during the rotation. The full engagement is seen in FIG. 8C. This motion can be facilitated if the lateral tips of the wings are tapered away from the flaps by an angle a such as better seen in FIG. 8C.

Referring back to FIG. 8B, firstly, it will be noted that the lower half 160 and the upper half 170 of the support insert 155 have a mating geometry with various features. In particular, the outer pair of wings and the inner pair of wings of the of the lower half 60 can be adapted to extend continuously with the inner pair of wings and the outer pair of wings of the upper half 170 in the configuration of use. Moreover, the lower half 160 can have a portion of a cylindrical conduit, and the upper half 170 can have another portion of a cylindrical conduit, forming, with the cylindrical conduit portion of the lower half, a cylindrical conduit adapted to receive the plant therein and extending into the cavity when assembled as shown. This cylindrical conduit slopes downwardly by an angle @ in the direction toward the cavity, as best seen in FIG. 8D. This downward sloping can help minimize any water droplets from entering the conduit from the cavity, and act somewhat as a gutter to guide any water droplets which have made their way into the conduit for one reason or another back into the cavity.

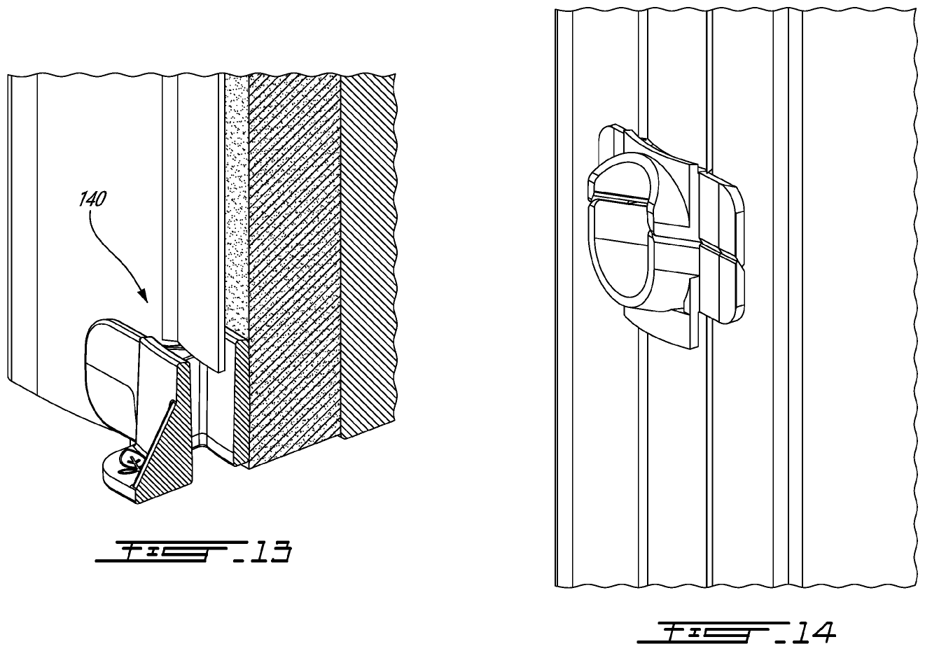

The footer insert 140 can be provided with similar features as the lower half or upper half, such as an outer pair of wings and an inner pair of wings and a height adapted to the width of the aperture, so as to allow introduction and engagement with the tower structure in a similar manner, as best seen in FIG. 13. However, the footer insert 140 may not have a conduit as it may not be configured in a manner to allow supporting a plant. Instead, the footer insert 140 may include a ledge or other structural feature which may provide suitable support against an underlying structure, such as a drain component.

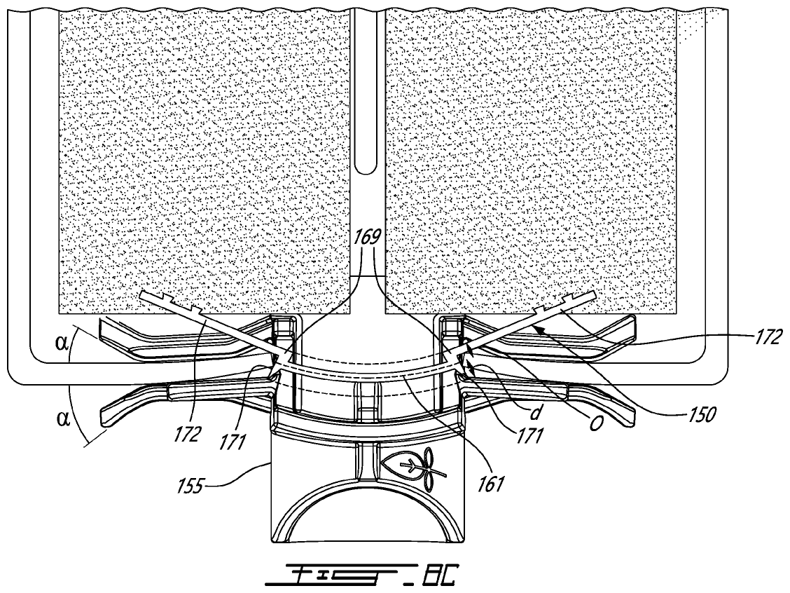

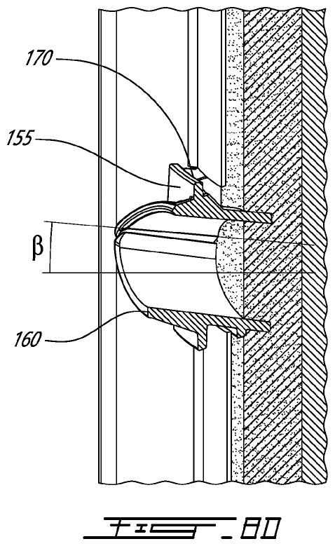

In this specific embodiment, the outward/front end of the upper half 170 of the conduit is rearwardly truncated, as best seen as schematized in FIG. 9A. This can help the stem of the plant held therein to grow more easily upwardly, in a natural manner.

It will also be noted, in this example embodiment, that the mating shape of the lower-half of the support insert and the upper half of the support insert are configured in a way which shields the cavity from light. Indeed, any paths which light may take to propagate from the outside of the cavity to the inside of the cavity across the support insert are minimized by the fact that apart from the cylindrical conduit, which receives the plant and which can be obstructed by the plant during use, the body of the upper-half and of the lower-half extend laterally across the aperture and span continuously from top to bottom. The lower half is configured to engage with a lower cover insert in this embodiment, and the upper half is configured to engage with an upper cover insert, and the lower half and the upper half are configured to engage closely with one another therebetween. The cylindrical conduit can be designed to protrude rearwardly in a manner to engage growth media such as shown in FIGS. 8C and 8D. This feature can help direct the roots of the plant into the gap between the two blocks of growing media, alongside the wicking strip. The location of the conduit portions, relative the wings, can be configured in a manner to facilitate the rotation of the support insert components during assembly.

FIG. 9A shows an example embodiment of a support insert 155 rom the front, and FIG. 9B shows the same example support insert from the rear. From these figures, many mating features of the top half and bottom half can be seen, which allow the upper half 170 and the lower half 160 to mate with one another and minimize any gaps, or allow the support insert to mate more efficiently with the cover inserts. In particular, the mating edges, 182, 184 of the cylindrical conduit portions can be seen to be beveled in a mating manner. Similarly, the mating edges of the wings 186, 188 can be seen to be beveled in a mating matter. This beveling is shown in greater detail in FIGS. 10A and 10B. This beveling can, among others, significantly reduce or eliminate any gap which may otherwise exist between the two halves and through which light could otherwise have propagated across the support insert, into the cavity.

Another significant feature of the support insert, which is shown in FIGS. 9A and 9B, is the presence of an upper face gutter system 190 on the upper half 170 of the support insert 155. Indeed, the upper face gutter system 90 includes two walls 192a, 192b which protrude vertically from lateral edges of the conduit. The top edge of these walls 192a, 192b can be beveled in a manner to slope toward the area between these walls 192a, 192b, which corresponds to the top portion of the cylindrical conduit, itself sloping towards the rear/cavity. Accordingly, water droplets which fall into the upper face gutter system 190 can become engaged between the vertical walls 192a, 192b and slide onto the outer face of the conduit to be channeled back against the growth media. A front wall 194 may also be present for structural reasons and/or to close off the front of the upper face gutter system 190.

Another significant feature of the support insert 155 is that it may be configured in a manner to form a structural column with the other inserts 150, 140, namely the cover inserts 150 and the footer inserts 140, which may vertically abut against one another along the aperture 23. More specifically, some vertically oriented engagement surfaces of the upper half 170 and of the lower half 160 may be configured to distribute load across the thickness of the support insert. More specifically, the support insert 155 may receive load from above, via the cover insert 150 located above, which may, itself, receive weight from a plant loaded in one or more support inserts located above it. Such loads may be redistributed to the cover insert located below. This structural column can terminate, in some cases, by the footer insert 140, which can be supported by a ground support. The weight of a plant received in the support insert 155 can also apply to the lower half 160 and be redistributed by the lower half 160 to the cover insert 150 located below it. The load received by the upper half 170 can be distributed to the lower half 160 via the engaged surfaces 182, 184, 186, 188. The upper half 170 can be configured to receive the load from an upper cover insert. In an example, the upper cover insert can rest on the walls 192a, 192b, which may further be used as columns to redistribute the load. Similar features to the walls 192a, 192b may be integrated to the lower half 160 of the support insert 155 to convey the load to the lower cover insert.

Optimal positioning of the cover inserts 150 relative the support inserts 155 may help in load distribution, and may also help in avoiding buckling of the cover insert 150. In some embodiments, it can be preferred for the support inserts (and the footer insert) to be provided with locating features, to limit the degree of freedom of the cover inserts in the front/rear orientation. More specifically, referring to FIG. 9B, the front wall 194 can act as a front limit, or stop, to the upper cover insert. A rear limit or stop may also be provided. In the illustrated embodiment, the rear limit or stop is provided in the form of a pair of protrusions protruding upwardly from the rear ends of the walls 192a, 192b. A transversally-oriented gap is left between the pair of protrusions, which allows the rearward escape of any water droplets received in the gutter system. In the case of the lower half and of the footer insert, a continuous wall may be used instead of a pair of protrusions, as these components may not need the spacing forming part of the gutter system in the upper half.

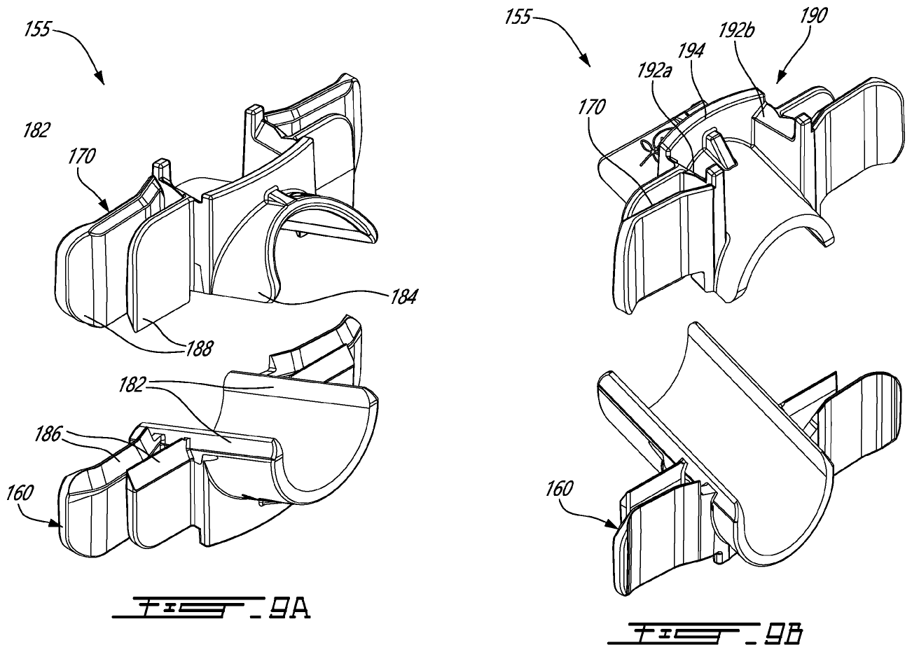

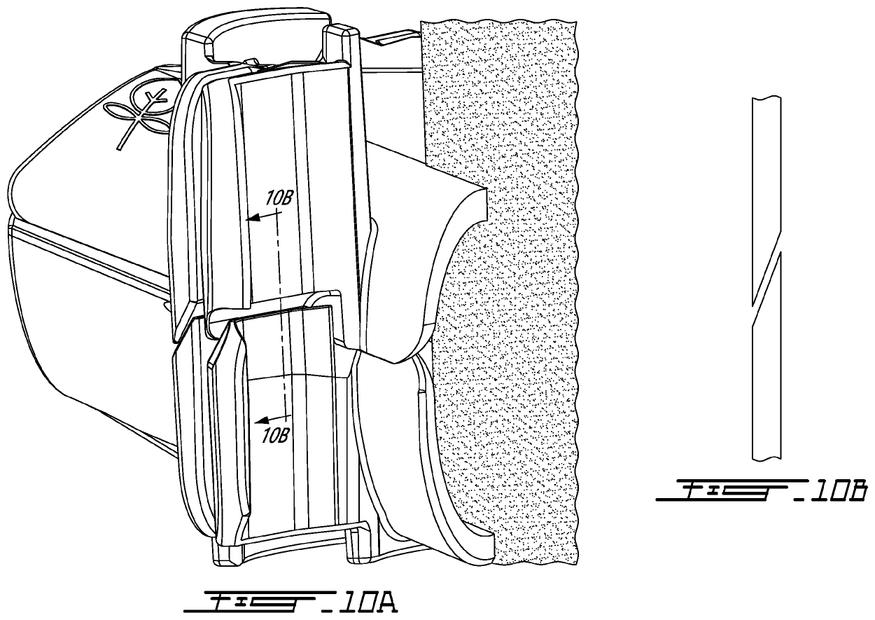

With reference to FIGS. 11A, 11B, and FIG. 8C, more details pertaining to the cover insert 150 of this embodiment, will now be provided. As best seen in FIG. 8B, the cover insert 150 in this embodiment is also made for production by extrusion, and therefore constitutes of a two-dimensional cross-sectional shape projected along an orthogonal axis. In this embodiment, the central portion 161 is also arc-shaped, and remains forwardly offset from the lateral portions by offsetting walls 169, but extends continuously between the two free edges of the vertical slit 23. In other words, the lateral width of the central portion coincides with the lateral width w of the vertical slit 23 during use, and with the lateral width of the support inserts 155. The free edges of the vertical slit 23 abut against the laterally external face of the offsetting walls, which can act as stops to maintain the relative position between the cover insert and the tower structure. The extent of the forward offset O between the central portion 161 and the lateral portions 172 can affect the balance between buckling resistance and transversal pliability. In some cases, a suitable balance may not lead to a sufficient depth of the offsetting walls 169 to provide suitable stopping activity to maintain the relative position. In such cases, such as in the illustrated embodiment, it can be preferred for projections 171 of the offsetting walls 169 to project past the location of the central portion 161 buy a distance d and form hooking protrusion which can help the function of abutment against the free edges of the vertical slit 23.

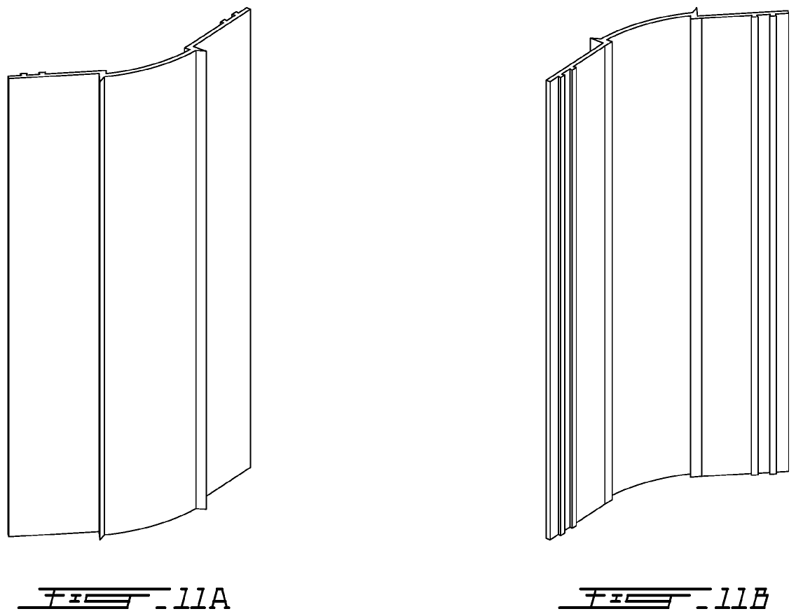

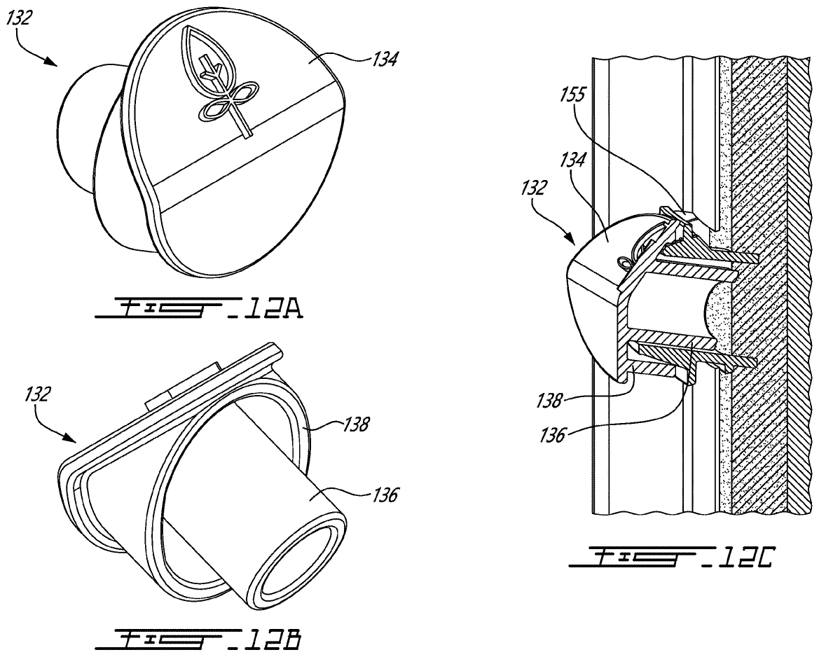

FIGS. 12A, 12B and 12C present an example of yet another insert which can be included as part of the vertical growth system 10 (or of a kit of parts to assemble same). This insert is a plug insert 132, and can be designed for closing off the stem channel of any support insert 55, 155 which is not actively loaded with a plant 29. Several features can be provided to allow the plug insert 132 to accomplish its function more efficiently. The plug insert 132 can have a face member 134 which is externally visible when the plug insert 132 is engaged with a support insert 155. The plug insert 132 can have an inner member 136, such as an inner tube, which can protrude rearwardly from the face member 134, and be designed to fit relatively closely with the internal diameter of the support insert's stem conduit (or plant passage), so as to be engaged therewith. The face member 134 can be designed in a way to fit closely with the outer edge of the insert's stem conduit, and potentially protrude transversally therefrom to provide even better light blockage. In some cases where a portion of the external tip of the support insert's stem conduit has different angles, such as the one of this embodiment where the outer edge of the upper half 170 slopes rearwardly, the face member 134 can be adapted accordingly and include more than one plane, fitting with the different angles of the edges. In the illustrated embodiment, the plug insert 132 further comprises an external tube 138 which partially overlaps the inner tube, and is designed to extend around the external portion of the support insert's plant passage, further blocking potential light entry pathways. In some alternate embodiments, the inner member 136 may be omitted, and the plug insert 132 may be held into place simply by the engagement between the outer tube, face member, and the support insert's protruding stem conduit. Alternately, in some embodiments, the outer member 138 may be omitted.

FIG. 13 is a cross-sectional view of the footer in the configuration of use, showing more detail of how the footer may be implemented in some embodiments. In this example, the footer has a vertically-oriented conduit circumscribed by a front wall, a rear wall, and two transversal walls. The vertically-oriented conduit may direct any water droplets received therein into the drainage system or drain, for instance. The front wall and rear wall may protrude upwardly from the transversal walls and act as a front stop and a rear stop for the cover insert received above it.

FIG. 14 presents a variant of a support insert. In this example, the support insert has a bigger conduit than the conduit of the support insert shown in FIG. 8D, and the lower half is provided with a conduit portion which has an obround cross-sectional shape rather than a circular cross-sectional shape. It will be understood that many further variants are possible.

As can be understood, the examples described above and illustrated are intended to be exemplary only. The scope is indicated by the appended claims.

1-33. (canceled)

34. A cover insert for a vertical growth system having a tower structure having wall having a vertical slit, and growing media housed behind the wall, the cover insert being generally sheet-like and elongated along an extrusion axis, with two wing portions protruding laterally, relative the extrusion axis, from a central portion, the central portion being curvilinear with an arc-shaped cross-sectional shape, the central portion being connected to the wing portions at opposite lateral edges thereof via offsetting walls, and being forwardly offset from the wing portions, the offsetting walls projecting past the central portion and forming hook members against which free edges of the vertical slit come into abutment when in a configuration of use with the wing portions trapped between the wall and the growing media.

35. The cover insert of claim 34 wherein the wing portions are straight, and have ridges on a rear face thereof.

36.-44. (canceled)

45. The cover insert of claim 34 further comprising one or more rear protrusions extending from a rear side of each one of the two wing portions, the one or more rear protrusions engageable with the growing media.

46. The cover insert as defined in claim 45, wherein the one or more rear protrusions are disposed adjacent an outer lateral edge of the wing portions.

47. The cover insert as defined in claim 45 wherein the one or more rear protrusions extend along the extrusion axis.

48. A system for growing a plant, comprising:
a vertical growing structure having a plurality of walls delimiting a cavity, a vertical slit extending along a vertical length of one of the walls between a first portion and a second portion of the one of the walls, a growing media disposed in the cavity; and
a cover plate including a covering portion disposed in the vertical slit, between the first portion and the second portion of the one of the walls, a first side portion extending transversely from the covering portion, the first side portion trapped between the first portion of the one of the walls and the growing media, and a second side portion extending transversely from the covering portion in a direction opposite the first side portion, the second side portion trapped between the second portion of the one of the walls and the growing media, trapping of the first side portion and the second side portion retaining the cover plate in the vertical slit, the covering portion at least partially covering the vertical slit.

49. The system as defined in claim 48, wherein the first side portion and the second side portion are bendable relative to the covering portion.

50. The system as defined in claim 48, further comprising one or more front protrusions extending from a front side of one or more of the first side portion the second side portion, the one or more front protrusions engageable with an inner surface of the one of the plurality of walls.

51. The system as defined in claim 50, wherein the one or more front protrusions are disposed adjacent a junction between the covering portion and the one or more of the first side portion and the second side portion.

52. The system as defined in claim 48, further comprising one or more rear protrusions extending from a rear side of one or more of the first side portion and the second side portion, the one or more rear protrusions engageable with the growing media.

53. The system as defined in claim 52, wherein the one or more rear protrusions are disposed adjacent an outer lateral edge of the one or more of the first side portion and the second side portion.

54. The system as defined in claim 48, wherein the first side portion and the second side portion are disposed in an offset plane from the covering surface.

55. The system as defined in claim 54, wherein the offset plane is defined by ninety degree bends in the cover plate connecting the covering surface to the first side portion and to the second side portion.

56. The system as defined in claim 54, wherein the covering surface is forwardly offset from the first side portion and the second side portion.

57. The system as defined in claim 48, wherein the covering surface is sized to correspond with a width of the vertical slit.

58. The system as defined in claim 48, further comprising a plurality of the cover plate, wherein the plurality of the cover plate substantially cover the vertical slit along the vertical length of the one of the plurality of walls.

59. A method for supporting a plant growing in a growing media in a cavity of a vertical growing structure, comprising:
inserting a cover plate in a vertical slit extending along a vertical length of a wall of the vertical growing structure, the cover plate including a covering surface and first and second side portions extending transversally from opposite sides of the covering surface, said inserting including folding the first and second side portions towards one another, inserting the first side and second side portions through the aperture, trapping the first and second side portions between an inner surface of the wall and the growing media, and aligning the covering surface with the vertical slit.
